(19) United States
(12) Patent Application Publication
(10) Pub. No.: US 2025/0061452 A1
(43) Pub. Date: Feb. 20, 2025

(54) MEDIATED ANONYMOUS NEGOTIATION SYSTEM

(71) Applicant: Sunhub LLC, Cleveland, OH (US)

(72) Inventors: Kadeer Beg, South Plainfield, NJ (US); Azam Kazmi, Strongsville, OH (US); Mitch Bihuniak, Rocky River, OH (US)

(73) Assignee: Sunhub LLC, Cleveland, OH (US)

(21) Appl. No.: 18/233,781

(22) Filed: Aug. 14, 2023

(51) Int. Cl. G06Q 20/38; G06Q 20/40

(52) U.S. Cl. CPC G06Q 20/383; G06Q 20/4014; G06Q 20/405; G06Q 2220/00

(57) ABSTRACT

An electronically networked mediated anonymous negotiation system and method are provided. A seller-side communication console has a transaction panel adapted to bidirectionally communicate product offer data with a moderator-side transaction management panel. A seller-side acceptance feature is configured to transmit to the moderator-side transaction management panel a manifestation of assent to the product offer. A buyer-side communication console is similarly equipped. A moderator-side mediation console has a transaction management panel adapted to bidirectionally communicate product offer data with the seller-side transaction panel, and to bidirectionally communicate product offer data with the buyer-side transaction panel. A multilateral chat feature is in bidirectional data communication with a seller-side chat panel, and in bidirectional communication with a buyer-side chat panel.

### I. BACKGROUND OF THE INVENTION

### A. Field of Invention

The invention generally relates to systems and methods for multilateral negotiations of contracts for the sale of goods and services in a digital network environment.

### B. Description of the Related Art

Digital computers and the Internet have long been used as tools for carrying out various commercial transactions. For example, Internet auction websites are well-known means for individuals and businesses to buy and sell products. Typically, buyer and seller both have authenticated accounts with an auction platform, such as eBay. The seller lists a product for bid, specifying certain parameters necessary for forming a binding contract e.g., a listing IDentification, product specifications, delivery terms, and certain other parameters setting the terms of the auction e.g., the start and end time of the auction, a starting bid or reserve price, bidding increments, and so on. On such platforms, the buyer and seller are typically provided with some form of direct communication permitting a bidder to ask questions about the product. The winning bidder pays the seller through the platform, the seller ships product to the winner according to the agreed terms, and the platform profits by charging a commission on the transaction. The contract formed in such an auction is between the seller and the winning bidder. Other contracts may govern the relationship of the buyer or seller with the platform provider, but the platform provider generally is not a party to the contract between the buyer and seller.

It is also known to have e-commerce stores such as Costco.com, where the store buys goods wholesale and warehouses them pending retail sale either through a brick and mortar store, or through its e-commerce store. When a buyer purchases an item through such a site, a contract is formed between the e-commerce store and the retail purchaser. Similarly, e-commerce platforms such as Amazon.com sell certain goods that they purchase wholesale; however, Amazon also provides e-commerce services allowing others to have an e-commerce store within the Amazon platform. Although the platform participates in transactions to varying degrees, and takes a commission, consummation of a sale results in a contract between the buyer and seller.

Platforms like Upwork are also known that allow freelancers to connect and contract with others through their system. Buyers and sellers of services use the platform to negotiate terms through direct communication with each other, and execute a contract for services. Such platforms typically include workrooms where the contracted services are actually provided, and payment must be made through the platform so that the platform service provider can collect its commission. Like other existing platforms, Upwork is not a party to the contract between the freelancer and employer.

Retail stock trading platforms like TDAmeritrade.com provide a brokerage platform through which securities are exchanged anonymously between a buyer and a seller. While such platforms provide anonymity, they do not provide a means for interactive negotiation. To the extent that retail stock trading platforms permit negotiation, it is limited to making an offer to buy or an offer to sell a specified security under certain specified conditions conforming to predetermined order types e.g., market orders, limit orders, stop orders, and so on. Such offers are made to an entire market, any member of which may accept the offer as-is. A brokerage may fill an order when the terms of an offer to buy and an offer to sell correspond. Otherwise, there is no opportunity to interactively negotiate custom terms, and there can be no counteroffer.

A platform for mediating an interactive negotiation between anonymous parties to a transaction, culminating in a binding contract, is not known in the art. All of the prior art has certain deficiencies. Some embodiments of the present invention may provide one or more benefits or advantages over the prior art.

### II. SUMMARY OF THE INVENTION

The invention provided herein is a unique solution to an e-commerce problem peculiar to conducting trade through the Internet. Particularly, existing commercial platforms do not permit anonymous negotiation between a buyer and seller. The invention relates to a platform technology including systems and methodologies for anonymously negotiating bilateral and multilateral contracts in the trade of goods and/or services. Anonymity is achieved using the platform as an intermediate party to a plurality of transactions that effectively isolates the buyer and seller from each other. A buyer and seller are enabled to anonymously negotiate and execute a given trade by dividing the transaction into two or more contracts, where the buyer and seller are not parties to the same contract, and do not communicate directly with each other. Live real-time negotiations occur with an intermediary through the platform. The intermediary may even contract with others. For instance, if the seller and buyer cannot agree on shipping terms, the intermediary is enabled to contract with a logistics company to handle shipment and pass the costs on to the seller, buyer, or both.

System and method embodiments of the invention provide a means for listing a given good or service for sale or for bid on the platform. A product listing method may be carried out through an Internet application that a buyer may access through a browser on any Internet enabled device, such as a personal computer or mobile device. The seller inputs data through the application to identify the good or service, and transactional terms sufficient to generate a listing that legally constitutes an offer for sale. A platform moderator reviews the draft listing to ensure the quality of each listing, and may add a commission to the listing. Each listing is a data record unambiguously identified with a unique alphanumeric code, termed a listing ID. The offer could be accepted as-is, or an anonymous bifurcated negotiation may take place through an intermediary. Bifurcated negotiation takes place in isolation between the moderator and a party, to the exclusion of other parties. A bifurcated negotiation is also referred to herein as a moderated negotiation.

One or more counteroffers may be made by the buyer and/or seller before an agreement is reached, and a binding contract is made, through the platform. Each such counteroffer may be defined by a data record containing a subset of the parameters defining the listing e.g., price, shipping terms, and/or other negotiable elements of the listing. As a matter of design choice, a counteroffer data record may explicitly include all or some other parameters of the listing, or the counteroffer may include a reference to the listing e.g., by listing ID, such that terms remaining constant between the listing and the counteroffer data records are not repeated in the counteroffer, but are nonetheless incorporated by reference or implicit in the counteroffer. A reference to redundant terms would be a more efficient use of system resources than explicit incorporation and would improve performance of the platform; however, either option is theoretically possible and within the scope of the invention.

The various counteroffers are made between the buyer and moderator, and the seller and moderator, and may include other parties as well; however, the buyer and seller do not negotiate or contract directly with each other. Eventually, the intermediary may arrive at a set of agreements with the buyer and seller individually, each of which mutually benefits the various parties, including the intermediary. Arriving at such an agreement is not required, and in some cases no contract will form. In other cases, the intermediary may need to engage parties other than the buyer and seller in separate contracts to provide a service necessary to reach an agreement with a buyer, a seller, or both.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a schematic diagram of an embodiment resulting in separate contracts between seller and mediator, and between buyer and mediator;

FIG. 2A is a schematic diagram of an embodiment resulting in a multilateral contract where negotiation is anonymous but a contract results between the buyer and seller;

FIG. 2B is a schematic diagram of an embodiment resulting in contracts between a buyer and a mediator, a seller and the mediator, and a third party service provider and the mediator;

FIG. 3 is a schematic diagram showing details of a seller-side communication console according to an embodiment;

FIG. 4 is a schematic diagram showing details of a buyer-side communication console according to an embodiment;

FIG. 5 is a schematic diagram showing components of a moderator-side communication console according to an embodiment;

FIG. 6 is a schematic diagram showing details of a moderator-side seller subpanel according to an embodiment;

FIG. 7 is a schematic diagram showing details of a moderator-side buyer subpanel according to an embodiment;

FIG. 8A is a line drawing of an example seller-side listing panel according to an embodiment;

FIG. 8B is a line drawing of an example moderator-side listing approval status screen according to an embodiment;

FIG. 9 is a line drawing of an example web browser interface according to an embodiment of the invention, showing product listings;

FIG. 10 is a line drawing of an example buyer-side bidding and inquiry messaging screen according to an embodiment;

FIG. 11 is a line drawing of an example moderator-side transaction management panel according to an embodiment;

FIG. 12 is a line drawing of an example seller-side chat screen according to an embodiment;

FIG. 13 is a line drawing of an example buyer-side chat screen according to an embodiment;

FIG. 14 is a line drawing of a generalized example of a buyer, seller, or third party chat screen according to an embodiment, including a left-side panel of offers or bids;

FIG. 15 is a line drawing of a moderator-side buyer chat screen according to an embodiment; and

FIG. 16 is a line drawing of a moderator-side seller chat screen according to an embodiment.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the enablement requirement, written description requirement, and the definiteness requirement of 35 U.S.C. 112.

As used herein, the terms moderator, moderation, moderated and so on, in reference to negotiations, mean that the negotiation is bifurcated. For example a moderated negotiation between a buyer and seller does not take place with all three of the buyer, seller, and moderator in common communication. Rather, the moderator negotiates with each party to the exclusion of the other with the aim of bringing buyer and seller close enough to agreement that a tripartite transaction can be executed in two or more contracts, with the moderator earning a commission or other compensation. Moreover, negotiations may have higher degrees of branching than bifurcation. For instance, the moderator may have to engage other parties to provide services enabling the transaction, such as shipping, insurance, and various financial services. A moderator may be a human user of the platform, or a bot. For example, the moderator may be a large language model (LLM) suitably trained to correspond with human users and facilitate negotiations. Embodiments employing an artificial intelligence, such as an LLM, may also include safeguards to ensure that the LLM behaves as expected, or within certain limited boundaries. Such safeguards may take the form of software code or training data, for instance. A moderator may also be a rule-based automation module containing scripted responses triggered by predetermined inputs. In any event, the moderator is an agent of the platform provider.

As used herein, the term intermediary is a general term denoting any party between a buyer and a seller whose function is to engage in negotiations and form contracts with a buyer, a seller, and potentially others. Accordingly, a broker is a kind of intermediary according embodiments of the invention. The terms intermediary, mediator, broker, and moderator are used interchangeably herein.

As used herein, the term console refers to a combination of readouts and/or displays of a software, and input features such as known graphical user interface controls by which an operator can monitor and interact with a system. Furthermore, as used herein, consoles comprise one or more panels. Panels are subsets and groupings of the console's readouts, displays, and input features. The groupings may be effected by arranging the console's readouts, displays, and input features on a plurality of screens, one screen, and/or selected regions of a screen for purposes of improved user experience, and as a matter of design choice. Panels may or may not be visually distinguished from one another by anything more than their selection and arrangement on a screen, meaning that a distinct panel need not be set off by a frame or other visual indicium. The invention is not limited to a particular arrangement of screens, panels, features or consoles. Moreover, a feature appearing on one panel may also appear on another without departing from the invention.

The acronym GUI stands for graphical user interface, and has its conventional meaning in the field of software engineering. Embodiments are described herein in terms of a graphical user interface(s).

The term data record is used herein to indicate an organized grouping of related data. Data records may be recorded in, for example and without limitation, a relational database. Data records may additionally or alternatively take the form of known data structures such as arrays, linked lists, or hash tables. The term data record is intended to indicate an organized grouping of related data without regard to a particular form or organizing modality. The person having ordinary skill in the software programming arts will be able to select an appropriate modality as a matter of design choice. For purposes of illustration only, data records are often discussed herein in the context of a relational database; however, the invention is not restricted to relational databases.

The term offer is used herein according to its meaning in contract law indicating terms of a proposed transaction that are sufficiently complete to create a binding contract upon acceptance without further negotiation. The term offer is also used herein to indicate an offer of the seller, in contrast to the word “bid” which is used herein to distinguish a buyer's offer from that of the seller.

The following detailed description of the drawings sets forth particular non-limiting embodiments of a platform system and related methods including certain use cases. The person having ordinary skill in the art will readily understand that all such embodiments and use cases are for illustration purposes only, rather than for purposes of limiting the invention in any way.

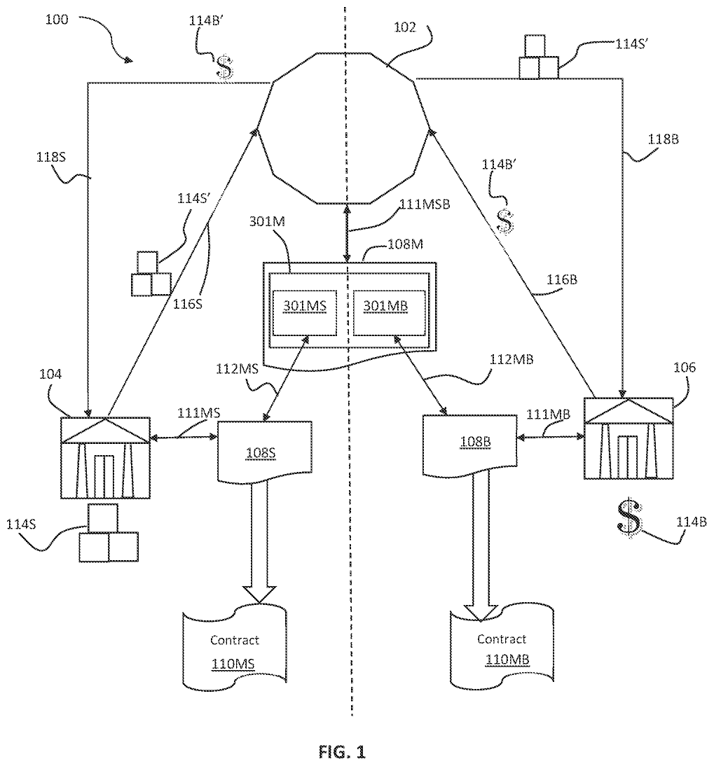

Referring now to the drawings wherein the showings are for purposes of illustrating embodiments of the invention only and not for purposes of limiting the same, FIG. 1 is a schematic diagram of one embodiment 100 of the invention. A seller 104 has a product 114S that buyer 106 is interested in acquiring either in whole or in part. Buyer 106 has the funds or other consideration 114B to purchase the goods 114S. Buyer 106 and seller 104 may be competitors, or may have some other motivation for seeking an anonymous platform to trade the product 114S and consideration 114B. For anonymity they engage intermediary 102 through the platform 100. The intermediary 102 provides a platform 100 for making the transfer 118B of at least a portion 114S′ of product 114S to the buyer 106, and transfer 118S at least a portion 114B′ of the consideration 114B to the seller 104 through the formation of two separate contracts 110MS, 110MB. A first contract 110MS is between seller 104 and moderator 102, and a second contract 110MB is between buyer 106 and moderator 102. The contracts are negotiated 112MS, 112MB through the platform 100 using networked computers running software components of the invention.

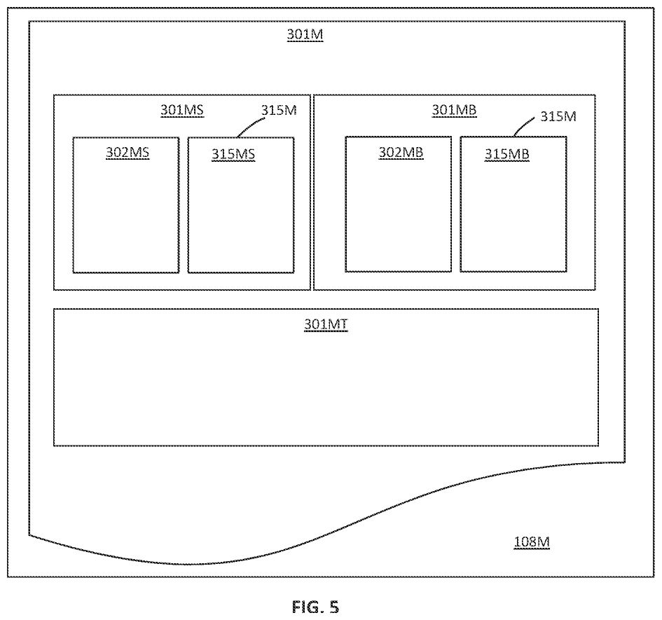

The platform 100 operates in a digitally networked environment. For example and without limitation, the moderator 102, seller 104, and buyer 106 may interact 111MS, 111MB, 111MSB with the platform 100 through network-enabled personal computers communicating through Internet protocols, while the platform 100 (again by way of non-limiting example) may operate in a cloud server environment. A seller's computer may run a seller-side communication console 108S in bidirectional data communication 112MS with a moderator-side mediation console 108M (See FIG. 5), and more specifically in bidirectional data communication 112MS with a moderator-side transaction management panel 301M (See FIG. 5) of the console 108M. Still more specifically, the seller-side communication console 108S is in bidirectional data communication 112MS with a seller subpanel 301MS of the moderator side transaction management panel 301M. The buyer-side communication console 108B is similarly in bidirectional communication 112MB with the moderator-side mediation console 108M, moderator-side transaction management panel 301M, and a buyer subpanel 301MB.

With continuing reference to FIG. 1, the buyer 106 and the seller 104 separately negotiate with the moderator 102 through their respective lines of bidirectional data communication 112MB, 112MS. In some embodiments an agreement between the moderator 102 and the buyer 106 may be made contingent on reaching a separate corresponding agreement with the seller 104 and vice versa; however, this is not a requirement of the invention. Where a moderator-seller contract 110MS forms and/or a moderator-buyer contract 110MB forms, rights to at least a portion 114S′ of the goods 114S and/or at least a portion 114B′ of the consideration 114B transfer 116S, 116B to the moderator 102 along with the corresponding obligations to render payment and deliver goods. By these agreements, the moderator 102 assigns 118S, 118B rights to the seller 104 and buyer 106 and effects transfer of the products 114S′ and consideration 114B′ to them, deducting an agreed commission.

The chain of possession of the products 114S′ and consideration 114B′ may or may not be the same as the flow of rights. For example, the flow of rights and obligations according to embodiment 100 is as follows. The contract 110MS between seller 104 and moderator 102 creates in the seller 104 a right to payment and an obligation to deliver product. The same contract 110MS creates in the moderator 102 a right the seller's product 114S, and an obligation to pay the seller 104 an agreed price. The corresponding contract 110MB between the moderator 102 and buyer 106 creates in the moderator 102 a right to payment from the buyer 106 and an obligation to deliver product 114S′ to the buyer 106. The same contract 110MB creates in buyer 106 the obligation to pay moderator 102, and the right to receive product 114S′. While all rights and obligations flow through the moderator 102 to the buyer 106 and seller 104, the moderator 102 may never take possession of the products 114S′. Rather, the moderator 102 may simply arrange for pickup of the products 114S′ from the seller 104, and delivery of the products 114S′ directly to the buyer 106. Similarly, the consideration 114B′ may be transferred to an escrow account under the moderator's control and transferred to the seller 104 upon a triggering event such as pickup of the products 114S′ at the seller's place of business by a common carrier.

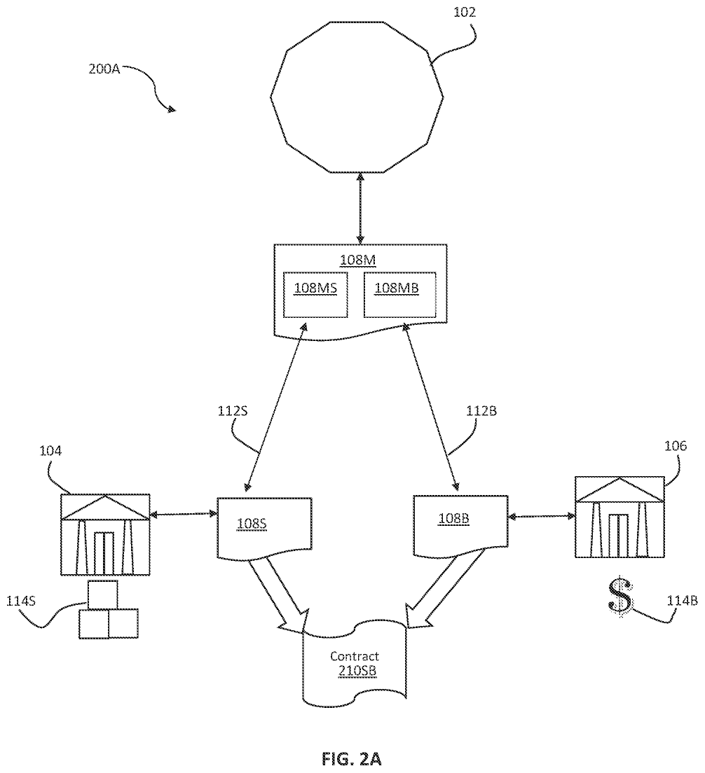

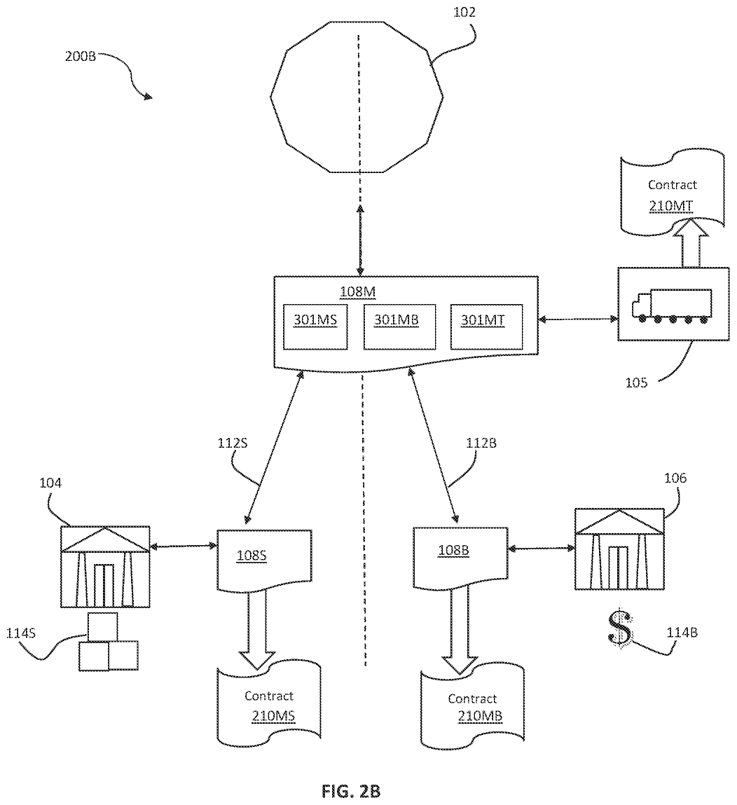

FIG. 2A illustrates an embodiment 200A that is similar to embodiment 100, except that the anonymous negotiations culminate in a bilateral contract 210SB between the buyer 106 and seller 104. In this embodiment 200A, rights and obligations transfer directly between the buyer 106 and seller 102 rather than through the moderator 102. The buyer 106 and seller 104 may still avail themselves of an escrow account under the moderator's control. An escrow account may be advantageous to create trust between the anonymous parties, and may provide a means for the moderator 102 to collect its service fee, commission, and/or markup.

FIG. 2B illustrates an embodiment 200B similar to embodiment 100, except that the moderator 102 separately contracts 210MT with a third party such as a common carrier 105 to provide shipping services. This may be advantageous where the buyer 106 and seller 104 cannot agree on delivery terms. In such cases, the moderator 102 may arrange delivery and pass the costs on to the buyer 106 and/or seller 104 by adding the costs to the moderator's commission from the seller 104 and/or deducting it from the price that moderator 102 charges buyer 106. While this embodiment 200B is presented in terms of a common carrier 105, the third party 105 can be any third party service provider necessary for closing a given transaction. For example, and without limitation, other third party service providers 105 include banks, escrow services, insurance providers, installers, and so on.

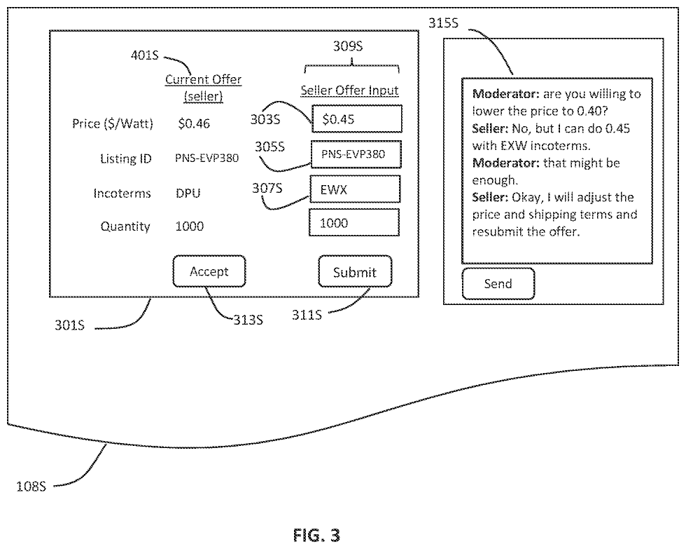

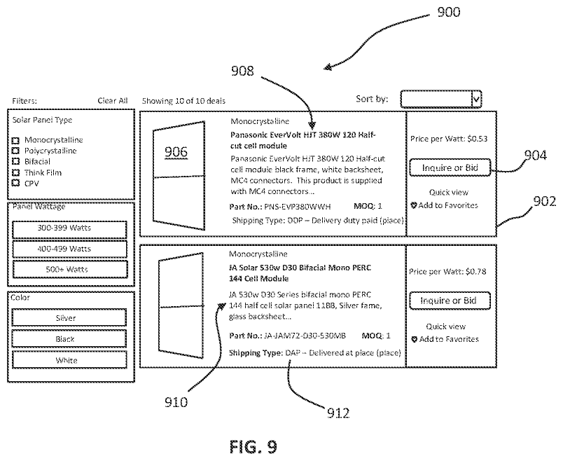

FIG. 3 illustrates a seller-side communication console 108S according to one exemplary embodiment. The console 108S has a seller-side transaction panel 301S. The panel 301S displays the seller's current offer 401S, which may be the seller's initial product offer, also referred to herein as a listing 902 (See FIG. 9), or any counteroffer of the seller 104. In the illustrated example, several counteroffers have already been made, and the seller's current offer 401S is a counteroffer. In instances where a buyer 106 simply accepts the seller's initial offer, without making a counteroffer, the seller may not need to open this seller-side communication console 108S except for creating the initial listing 902. On the other hand, if the buyer makes a counteroffer, the counteroffer would be transmitted from the buyer 106 to the moderator 102, and the moderator 102 would transmit its counteroffer to the seller 104, which can be accepted using a graphical user interface button control comprising an accept feature 313S. In the event the seller 104 accepts the current offer by clicking button 313S, the platform creates a contract data record, amounting to a legal contract 110MS between the moderator 102 and the seller 104, and having the terms of the original listing as modified by the then-current offer. A contract so formed may comprise the data of the contract data record, plus any additional standard or boilerplate terms as discussed in more detail elsewhere herein.

The data associated with the listing ID may be recorded to a new contract data record. Similar to listing and offer data records, a contract data record may be recorded according to known means such as in the form of records in a relational database identified by a contract ID, which may serve as a key. In the case where the seller 104 accepts, the current offer will necessarily be a counteroffer rather than the original listing. Therefore, the contract data record comprises the data associated with the listing ID as modified by the data associated with the then-current offer ID.

In the event that the seller wishes to make its own counteroffer, seller-side transaction parameter fields 309S are provided. The fields 309S are configured to record inputs relating to any data element comprising an offer data record. A few fields are shown in this example in FIG. 3 for purposes of non-limiting illustration, namely a price field 303S, a Listing ID field 305S, an Incoterms field 307S and others. The Incoterms field 307S is also referred to herein as a contract terms field, and may be used to more generally indicate Incoterms, payment schedule, payment terms (e.g. due on receipt, 30 day Net etc.), delivery schedule, accompanying product accessories (e.g. connectors), add-ons, warranty, service contracts, logistics fees, master service agreements, non-disclosure agreements, and terms and conditions. A seller 104 would input data corresponding to its desired counteroffer, and use a graphical user interface button control 311S comprising a submit feature to transmit the counteroffer to the moderator 102.

The offer data record corresponding to a given counteroffer would include the data specified by the seller 104 in one or more of the seller-side transaction parameter fields 309S, plus a unique offer ID code identifying and distinguishing the counteroffer from other counteroffers in this and other negotiations through the platform. An offer ID code can be formulated according to any convenient coding methodology provided it is unique and amenable to performing digital computing operations on the offer ID code. One suitable format for an offer ID code is an alphanumeric text string. Others include, for example and without limitation, binary, decimal, or hexadecimal numbering systems. The data comprising an offer data record may be stored according to known means such as in the form records in a relational database using the assigned offer ID code as a key, also referred to herein as an offer key. According to one non-limiting example, the offer data record may be assembled from data read from a product listing, and subsequently modified by a party to a transaction. An offer data record may also be constructed by copying the data elements of the next previous offer, changing one or more data elements as prescribed by a party, and assigning a new offer key.

Optionally, the seller 104 may engage the moderator 102 in a dialog through the seller-side chat panel 315S. For instance, the seller 104 may wish to enquire whether buyer is willing to raise its offer, or if the buyer would be willing to do so in exchange for e.g. alternative shipping terms. The seller's questions can be transmitted to a moderator 102 who will then negotiate with the buyer 106. When the seller 104 is satisfied with his counteroffer, he may click the submit feature 311S to transmit the counteroffer to the moderator 102. Alternatively, the moderator may reach out to the seller through the seller-side chat panel 315S e.g. in an attempt to bring the buyer and seller closer together. In FIG. 3, for instance, the moderator asks whether the seller is willing to lower its price to 0.40 $/watt. The seller responds “No, but I can do 0.45 with EXW incoterms”, and crafts a counteroffer accordingly. As shown in FIG. 3, the seller has inputted $0.45 and EXW terms into fields 303S and 307S respectively, and is about to click the submit button 311S. Since the seller has not yet submitted the counteroffer, the current offer 401S still reflects the seller's last offer. When the submit button 311S is actuated, the next previous offer data is read into a new offer data record with a new offer ID, and with the data in fields 303S and 307S overwriting the next previous values to which they correspond. The new offer is thus recorded and then transmitted to the moderator 102.

The person having ordinary skill in the art will understand that the data appearing under the current offer heading 401S need not be separate from the transaction parameter fields 309S. Rather, these data may be made default values of transaction parameter fields 309S, which may be edited. The person having ordinary skill in the art will further understand that the seller-side communication console 108S may include a separate listing panel, as described in more detail elsewhere herein, or the seller-side transaction panel 301S may also function as a listing panel.

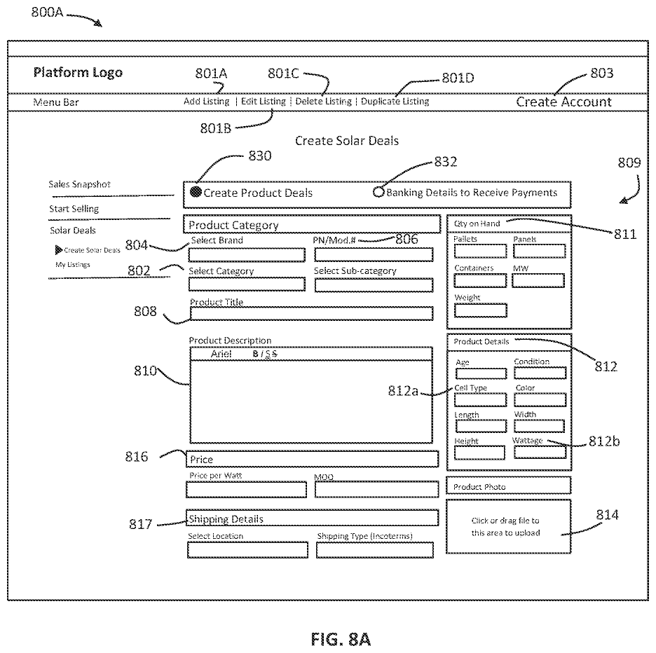

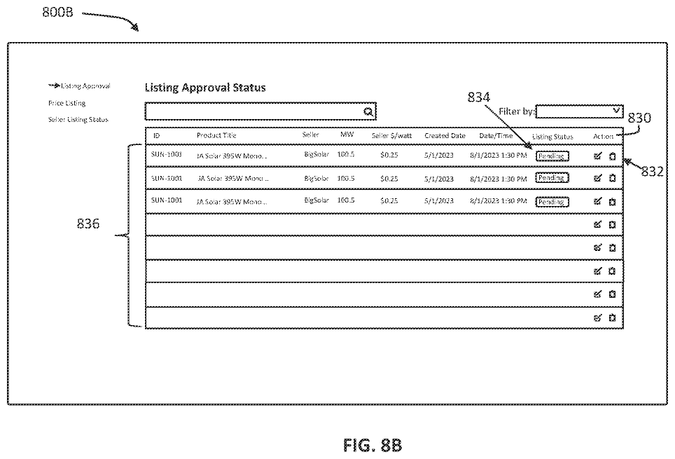

FIG. 8A illustrates a seller-side listing panel 800A according to one embodiment. In this particular non-limiting example, the product listing panel 800A is specially configured for listing solar energy equipment, which is meant only for illustration and not as a limitation of the invention. Nonetheless, many of the data elements in this example would be useful in selling many other products as well. For example, the listing panel 800A includes fields for identifying product category 802 and subcategory, a part number, model number, or SKU 806, a product title 808 for the listing, a narrative product description 810, and a product photo 814. Certain product details 812 specifically bearing on solar equipment include cell type 812a and wattage 812b. Other details necessary for forming a contract include pricing 816 and shipping details 817. As illustrated in FIG. 8A, shipping details 817 the location of the goods, and the shipping type (also referred to as Incoterms). In this particular embodiment, specially configured for solar equipment, pricing is quantified in currency units per watt, which is conventional in the solar energy industry. The person having ordinary skill will readily understand that price can be expressed in any convenient units to suit the product or conform to industry conventions. The panel 800A is also configured to specify the quantity of product on hand 811 to a desired level of granularity e.g., number of pallets, number of containers, the number of panels, megawatts (MW) and weight. A seller may sell less than all of the quantity identified in a listing to multiple buyers until the listing is depleted. Embodiments may update the quantity on hand as the listing is sold off.

With continuing reference to FIG. 8A, controls 830 and 832 are provided for selecting between a Create Product Deals screen and a Banking Details to Receive payments screen. As illustrated, the Create Product Deals screen is selected, and the data shown reflects this selection. If the Banking Details screen were selected, the user would see e.g. fields for routing number, account number, SWIFT number and so on. The platform may use banking data in part to enable payment, but also to authenticate users. For instance, the banking details may be validated by comparing e.g. a routing number to the American Banking Association's database of routing numbers, and/or by making one or more small deposits and corresponding withdrawal(s) from the bank account corresponding to the inputted routing and account number combination, and requiring the user to input data matching the amounts of the deposit and withdrawal. Authenticating contact details can be accomplished according to known methods such as through transmitting a token or numerical string by SMS text to a mobile number inputted by a user. In addition to authentication, users may be required to accept standard terms and conditions promulgated by the platform provider and e.g. governing user conduct on the platform, user responsibilities to the platform provider and to other users, and otherwise governing the relationship between the platform provider and the user. The platform may include features for displaying such terms and conditions to a user, and may further provide graphical user interface controls enabling the user to accept or reject the terms and conditions. Such features may be included on an account creation screen, and acceptance of the terms and conditions may be required as a condition of using the platform.

Embodiments may enable a buyer to buy less than all of the product contained in a listing. Therefore, a single listing may be subject to several transactions before the entire listing is sold out. Embodiments may also provide features for relisting. For example, a given part number, model number or SKU may be sold more than once. Therefore, it would be advantageous to reuse the details of a listing to produce a new listing quickly and without having to re-input all the necessary data. A draft listing based on an old listing may include all the details of the old listing while providing the seller with features to edit the details as-needed. The new listing may, for instance, be available in different quantities, or may be used rather than new.

Embodiments may also include an automatic field population feature whereby the system autopopulates fields by relating an inputted part number or similar indicium to other product data already recorded in the embodiment. New listings may draw from the existing library to more quickly populate data fields defining the new listing.

Collectively, the data inputted by a seller through the product listing panel 800A, including any autopopulated data, are recorded by the embodiment in a product listing data record that further includes a listing ID code, unambiguously identifying the listing and distinguishing it from other listings. A listing ID code can be formulated according to any convenient coding methodology provided it is unique and amenable to performing digital computing operations on the listing ID code. One suitable format for a listing ID code is an alphanumeric text string. Others include, for example and without limitation, binary, decimal, or hexadecimal numbering systems.

Similar to offer data records, a listing data record may be recorded according to known means such as in the form of records in a relational database, where the listing ID serves as a key, also referred to herein as a listing key. The listing data record so recorded, can be transmitted to a moderator 102 for editing and approval. The moderator 102 may, for example, exclude listings that are incomplete or that are clearly spam. Alternatively, the moderator 102 may alert the seller 104 to an irregularity in the listing that the seller 104 must attend to, or the moderator may edit the listing to correct obvious errors. The moderator may also manually or automatically assign a commission according to a predetermined formula, or according to the moderator's judgment.

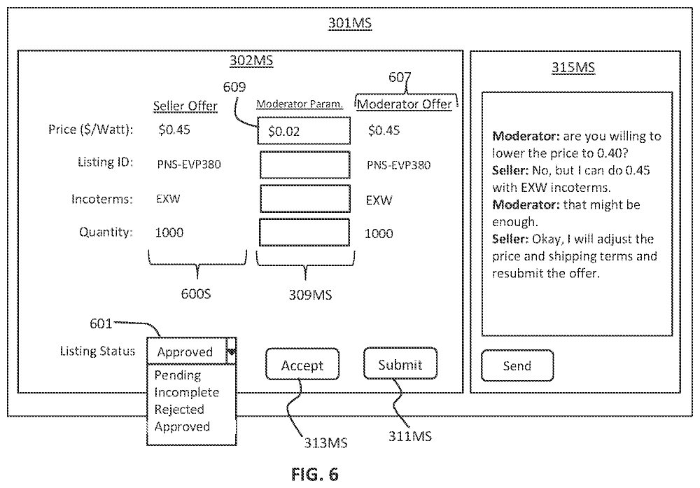

In FIG. 8B, a moderator-side product listing management screen 800B is shown. In some embodiments this screen may be a component of, or may cooperate with, the seller subpanel 301MS shown in FIGS. 5 and 6. For instance, in FIG. 6 a listing status dropdown box 601 is provided as a feature of the seller subpanel 301MS. This feature allows a moderator to approve or reject a particular new listing submitted by the seller 104 as described, for instance, in reference to FIG. 8A. In contrast, moderator-side listing approval status screen 800B (also referred to as a moderator-side product listing management panel (800B)) displays a plurality of listings including a status indicator 834, which may further comprise a dropdown box containing selectable listing statuses enabling a change in status. Such a feature 834 may also be referred to as a product listing status management feature 834. The listing approval status screen 800B also includes a plurality of tools 832 configured to enable the moderator to perform certain actions 830 or operations on a listing, including to approve, reject, edit, or delete a given listing. The person having ordinary skill in the art will understand that screen 800B may be provided instead of the listing status dropdown box 601 feature, or in addition to it.

According to embodiments of the invention, a buyer's computer may run a buyer-side communication console 108B in data communication with the moderator-side transaction management panel 301M. According to the embodiment illustrated in FIG. 1, the seller creates a product listing with sufficient detail to constitute an initial offer for sale that can be accepted, at least in theory, without modification, to form a binding contract. As noted elsewhere herein, a moderator is enabled to screen listings, edit listings, and add commissions to listings.

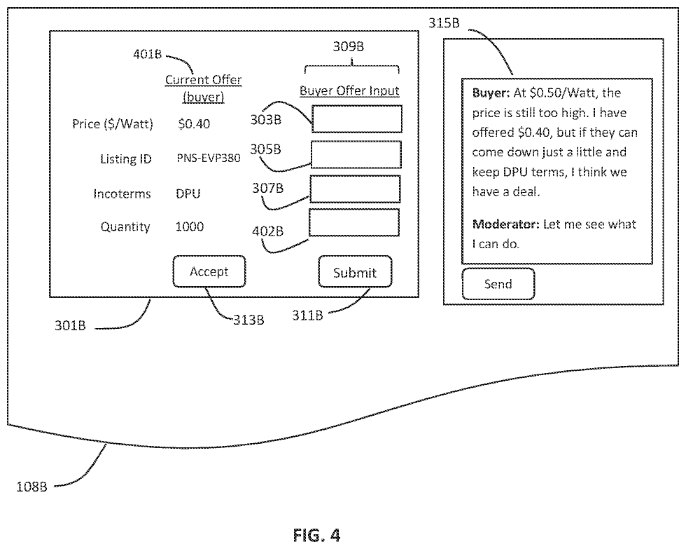

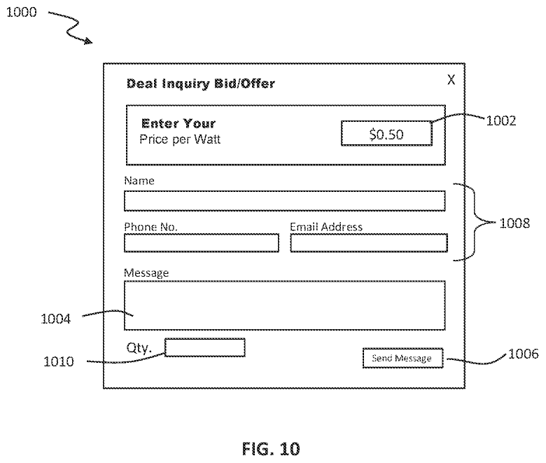

FIG. 9 shows an example product listing 902 displayed in a web browser interface 900, as seen for instance by a potential buyer. In this particular example, the product listings are solar panels identified by part number. A product photo 906, title 908 and brief product description 910 are also provided along with standard Incoterm® shipping terms 912. The illustrated listing is constructed by reading listing data corresponding to a given listing ID into fields of a graphical user interface, which fields have been selected, laid out, and rendered as a matter of design choice. A graphical user interface control is provided in the form of an “inquire or bid” button 904. Clicking this button may transport the prospective buyer to a buyer communication console 108B, as shown generally in FIG. 4 and with more particularity in FIG. 10.

Turning to FIG. 4, the buyer communication console 108B includes a buyer-side transaction panel 301B and a chat panel 315B. The transaction panel 301B of this embodiment displays the buyer's current offer details 401B. When the buyer views this panel 301B for the first time in a given negotiation, the buyer's current offer 401B details can be configured to default to that of the initial listing, providing the buyer with the option of simply clicking the accept feature 313B. In the event that the buyer accepts the current offer by clicking button 313B, a contract data record is formed, amounting to a legal contract 110MB between the moderator 102 and the buyer 106, and having the terms of the original listing as modified by the then-current offer.

The data associated with the listing ID may be recorded to a new contract data record. Similar to listing and offer data records, a contract data record may be recorded according to known means such as in the form of records in a relational database identified by a contract ID, which may serve as a key. In instances where the current offer is a counteroffer rather than an original listing, the contract data record may comprise the data associated with the listing ID as modified by the data associated with the then-current offer ID. The parties to a contract accepted by the buyer would be the buyer 106 and the moderator 102.

However, in FIG. 4, the buyer 106 is also provided with fields 309B for making a counteroffer. To make a counteroffer, the buyer uses the buyer-side transaction parameter fields 309B to input alternative terms. For example a price can be inputted through field 303B, shipping terms through 307B, and quantity through field 402B. Ordinarily, the listing ID input field 305B would not be used, and may be disabled or even absent. In embodiments where the listing ID is editable, changing the listing ID would repopulate the screen with data corresponding to the inputted listing ID. The person having ordinary skill will understand that data displayed under the current offer heading 401B need not be separate from the transaction parameter fields 309B. Rather, these data may be made default values of transaction parameter fields 309B, which may be edited.

Optionally, the buyer 106 may engage the moderator 102 in a dialog through the buyer-side chat panel 315B. For instance, the buyer 106 may wish to enquire whether the price is negotiable, or if alternative shipping terms are available. The buyer's questions can be transmitted to a moderator 102 who will then negotiate with the seller 104. When the buyer 106 is satisfied with his counteroffer, he may click the submit feature 311B to transmit the counteroffer to the moderator 102.

Turning to FIG. 10, an alternative buyer-side screen 1000 is provided for entering a bid or making an inquiry. As shown in FIG. 10, the screen includes a price field 1002 for entering a proposed new price, and a message field 1004 for entering a message to the moderator concerning any aspect of the transaction. For example, the buyer might inquire about whether shipping terms are negotiable and might suggest alternative terms here. In some embodiments, such as shown in FIG. 4, the screen 1000 may include additional data input fields for terms like shipping, financing, and any other terms comprising the original listing. The screen 1000 may further include contact details 1008 such as name, phone, and email. Contact details 1008 may be autopopulated from the buyer's authenticated account details but, as a matter of design choice, may remain editable. Finally, the screen 1000 further includes a quantity field 1010 in which a buyer or seller may enter a quantity subject to an offer or bid, which may be less than the total amount on hand as indicated in the listing (see e.g. FIG. 8A element 811).

Turning now to the moderator side of the platform, FIG. 5 is a generalized schematic line drawing of a moderator-side mediation console 108M. The console 108M is equipped with features enabling the moderator 102 to communicate with all parties and to manage listings and offers. More specifically, the console 108M includes a moderator-side transaction management panel 301M. For non-limiting purposes of illustration, the transaction management panel 301M is divided logically into regions having features for communicating with particular parties. Embodiments are not limited to the particular logical or spatial arrangement shown here, which would be a matter of design choice for the person of ordinary skill. By way of non-limiting example, the transaction management panel 301M comprises a seller subpanel 301MS having a set of seller-moderator transaction parameter display fields and/or input fields 302MS, and a seller chat subpanel 315MS for private chat communication with the seller 104. Similarly, the transaction management panel 301M includes a buyer subpanel 301MB having a set of buyer-moderator transaction parameter display fields and/or input fields 302MB, and a buyer chat subpanel 315MB for private chat communication with the buyer. The seller subpanel 301MS is in bidirectional data communication with the seller-side transaction panel 301S and the seller-side chat panel 315S. Similarly, the buyer subpanel 301MB is in bidirectional data communication with the buyer-side transaction panel 301B and the buyer-side chat panel 315B. Collectively, the seller chat subpanel 315MS and the buyer chat subpanel 315MB, may be regarded as a moderator-side chat subpanel 315M covering both parties. Subpanel 315M may also be referred to herein as a multilateral chat feature 315M. Some embodiments may spatially arrange the buyer and seller chat subpanels 315MB, 315MS such that they are displayed simultaneously side-by-side, while maintaining private bifurcated communications with the buyer and seller respectively. Other embodiments may provide a GUI control for toggling between the buyer and seller chat subpanels 315MB, 315MS.

With continuing reference to FIG. 5, a third-party subpanel 301MT is shown. Any number of such third-party subpanels can be provided. The number may correspond to the number of third-party service providers necessary to close a given transaction. For example, if the moderator needs to hire a logistics company to cover shipping, a third-party subpanel 301MT may be added for negotiating with the logistics company and generating a contract between the moderator 102 and the logistics company (see e.g. FIG. 2B elements 301MT, 105, and 210MT). If a financing company is also required, a second third-party subpanel may be added. In some embodiments, the number of third-party subpanels may be predetermined and fixed. In other embodiments the number may vary from one transaction to the next. Therefore, in such embodiments, the moderator may be afforded the flexibility and GUI features to add third-party subpanels 301MT as needed.

A platform may have relationships with preferred third-party service providers, such as logistics companies and banks, for providing services necessary to close a given deal. Apart from shipping, a logistics company may be needed for packaging, freight forwarding, or warehousing. A bank may be needed for wire transfers, ACH payments, deposit accounts, escrow accounts, lines of credit, letters of credit, and so on. Such third-party service providers may have authenticated accounts with the platform, and the platform may have pre-negotiated rates with the providers. Accordingly, third-party subpanels 301MT provide a means for quickly integrating a necessary third party into a complex multilateral transaction. Data may be manually entered into a third-party subpanel 301MT or automatically populated according to pre-negotiated terms. Similar to buyer and seller subpanels 301MB, 301MS, a third-party subpanel 301MT may include a chat feature enabling real time private chat with the provider to negotiate any non-standard terms. For example, a given lender may have a general rule that a certain credit score is necessary to extend credit at a certain rate; but, that rule may be waived according to business judgments made on a case-by-case basis. Obtaining such a waiver may be the difference between closing and not closing a given deal. An embodiment having one or more third-party subpanels 301MT enables a moderator to rapidly come to an agreement with service providers to close more transactions, and to do so faster and more profitably.

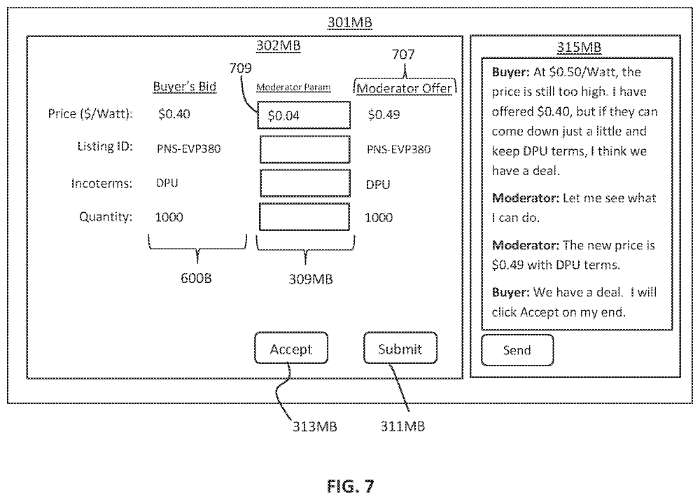

FIGS. 6 and 7 are illustrative non-limiting examples of moderator-side seller and buyer subpanels 301MS, 301MB showing features and example data provided to a moderator as part of the mediation console 108M. The seller subpanel 301MS is in data communication with seller-side transaction panel 301S, and displays transaction parameters 600S transmitted from the seller-side transaction panel 301S, representing the seller's most recent offer to the moderator. The moderator is also provided with moderator-side seller transaction parameter input fields 309MS, which enable the moderator to negotiate with the seller. For example, moderator has inputted a $0.02 per watt commission into commission field 609 to be paid from the seller's offer of $0.45 per watt. In other words, moderator will agree to pay seller a net $0.43 per watt. When moderator is satisfied with its terms, it will actuate the submit button 311MS of the graphical user interface to transmit its offer to seller, who may accept it or negotiate further. Alternatively, if the seller's most recent offer is agreeable, the moderator may actuate the accept button 313MS, creating a contract between the seller and moderator. The contract may be made contingent on closing a corresponding deal with buyer and any necessary third-party service providers. Contingency may be effected as a default term of the contract between seller and moderator; however, embodiments may alternatively comprise a GUI control(s) for selecting or enabling a contingency term.

As indicated in the moderator-side seller chat subpanel 315MS, the moderator asked seller if it could lower the price to $0.40. The seller indicated that it could not do so, but that it could lower the price to $0.45 per watt if the buyer can accept less favorable EXW Incoterms. Accordingly, with reference to FIG. 3, the seller entered these new deal parameters into the seller-side transaction panel 301S and transmitted them to the moderator via the submit button 311S. The terms now appear on the moderator side, as shown in FIG. 6. However, the moderator knows that DPU Incoterms are necessary to close the deal with buyer. Therefore, as shown in FIG. 7, moderator formulates its offer to buyer by marking up the price $0.04 per watt and changing the Incoterms back to DPU. Otherwise, the moderator's offer to buyer is the same as the seller's offer to moderator.

Through its private chat 315MB with the buyer, the moderator knows that it can likely close the deal by coming down any amount from its last offer of $0.50 per watt as long as moderator can provide DPU terms to buyer. The moderator can use the platform to separately contract with a logistics company to provide the necessary Incoterms, and still make a profit after a $0.02 seller-side commission and a $0.04 buyer-side markup. When the moderator is satisfied with its offer, the moderator actuates the submit button 311MS to transmit the offer to seller. The seller has indicated in the seller chat subpanel 315MS of FIG. 6 that it would accept.

FIG. 7 shows the buyer subpanel 301MB in data communication with the buyer-side transaction panel 301B. The buyer subpanel 301MB displays transaction parameters 600B transmitted from the buyer-side transaction panel 301B, representing the buyer's most recent offer to the moderator. The moderator is also provided with moderator-side buyer transaction parameter input fields 309MB, which enable the moderator to work up an offer for the seller, based upon the buyer's most recent offer.

As shown in FIG. 7, the buyer's most recent bid, or offer, is $0.40 per watt with DPU Incoterms. In the moderator-side buyer chat subpanel 315MB, the moderator and buyer are discussing the most recent offer of $0.50 per watt and DPU Incoterms. Buyer indicates that the price is still too high, but he would be willing to agree if the seller “can come down just a little and keep the DPU terms”. The moderator indicates that he will discuss it with seller, and returns to buyer with a new offer of $0.49 and DPU terms. As shown in FIG. 7, the moderator has already entered the terms into the moderator-side buyer transaction parameter input fields 309MB, including its $0.04 markup in a markup field 709, and actuated the submit button 311MB transmitting the offer to buyer. In the buyer chat subpanel 315MS of FIG. 7, the buyer has indicated that it will accept.

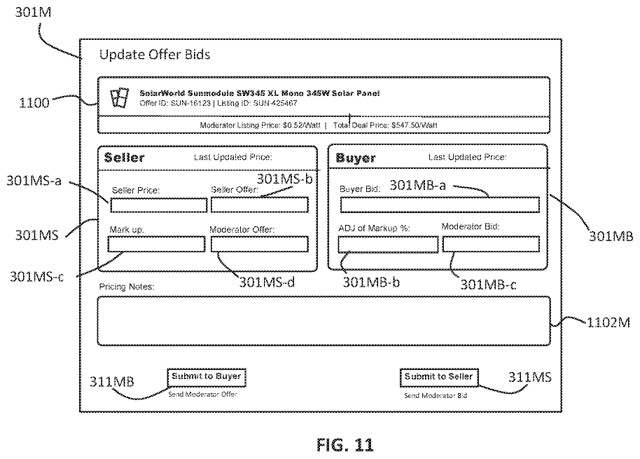

FIG. 11 illustrates a second form of the moderator-side transaction management panel 301M. The panel includes header data 1100 that identifies the product to which the pending transaction relates, including a title and product image pulled from the product listing. The product listing is identified by Listing ID. The header 1100 also includes an offer ID reflecting the most current offer tendered to a buyer or seller.

In this FIG. 11 version of the panel 301M, the seller subpanel 301MS is limited to seller price 301MS-a, seller offer 301MS-b, markup 301MS-c, and moderator's offer to buyer 301MS-d including the specified markup. According to the embodiment shown in FIG. 11, the value of the moderator offer field 301MS-d would be the sum of the seller's offer 301MS-b and the markup 301MS-c. The seller price 301MS-a is the original listing price of the product under negotiation, whereas the seller offer 301MS-b is the seller's latest counteroffer. The markup is expressed as a percentage of the seller offer 301MS-b. Where the seller has made no counteroffer, the seller offer 301MS-b would be equal to the seller price 301MS-a.

The FIG. 11 version of the buyer subpanel 301MB is limited to the buyer's bid 301MB-a, the moderator's bid 301MB-c and an adjustment for the moderator's markup 301MB-b. The buyer's bid 301MB-a reflects the amount the buyer is offering to pay for the product under negotiation. The moderator's bid 301MB-c is what will be transmitted to the seller by the moderator, which is equal to the buyer's bid 301MB-a plus an adjustment ADJ 301MB-b. In order for a transaction to close, the moderator's offer 301MS-d must equal the moderator's bid 301MB-c. In some instances the moderator may be willing to decrease its markup 301MS-c or increase its bid 301MB-b in order to close a transaction. Provided that, in units of currency, the markup 301MS-c is larger than the adjustment 301MB-b, the moderator makes a profit from the transaction. The moderator's profit is a cost of the transaction to the buyer and/or seller. The moderator will use its business judgment to determine how to allocate transaction costs among the buyer and seller.

With continuing reference to FIG. 11, the moderator is provided with a note pad 1102M where the moderator can keep private notes concerning the negotiation and pending transaction. The notes are separate from the chat feature, and are not transmitted to the buyer or seller. Below the note pad 1102M, are GUI buttons “Submit to Buyer” 311MB and “Submit to Seller” 311MS. The person having ordinary skill will recognize that placement and positioning of the buttons is not a feature of the invention, and is a simple matter of design choice. Actuating the Submit to Buyer 311MB button transmits the data in the moderator offer field 301MS-d to the buyer. Similarly, actuating the Submit to Seller button transmits the data in the moderator bid field 301MB-c to the seller.

In the embodiment illustrated in FIG. 11, the moderator is not provided with an accept feature. Accordingly, the buyer and seller must individually actuate (i.e. click) their respective GUI accept buttons 313MB, 313MS in order to close the transaction. Until both the buyer and the seller manifest their assent to the terms, the transaction overall remains contingent. Upon closing, at least two contracts are formed. One contract between the seller and moderator, and a separate contract between the buyer and moderator. As discussed in more detail elsewhere herein, other contracts may also form in the event that parallel negotiations between the moderator and one or more service providers is necessary to close.

Embodiments may optionally include an electronic signature feature. To the extent that a contract can be formed through manifesting assent without a signature, such as through actuating an accept button, an electronic signature is not required. However, an electronic signature may be advantageous to prove that a contract was in fact formed, and to identify the signatories.

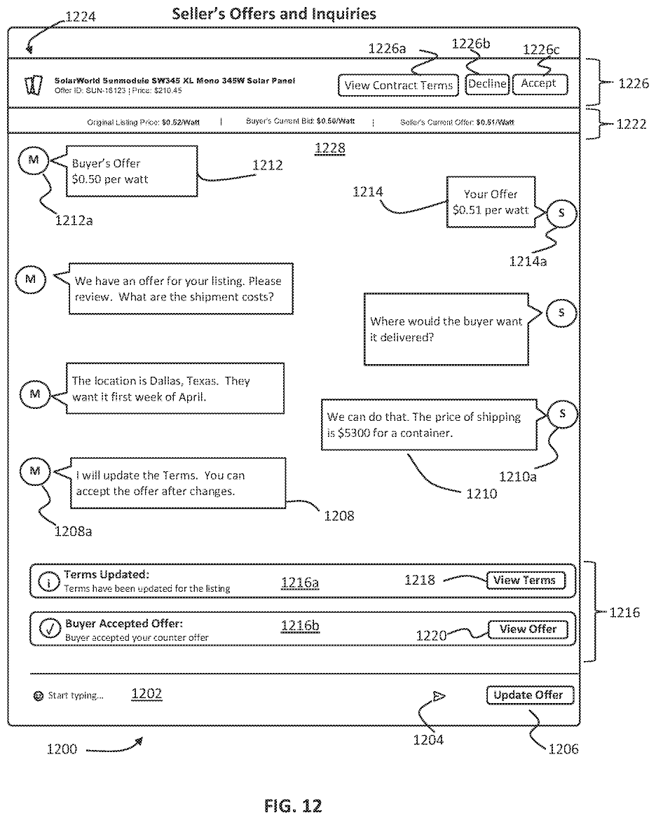

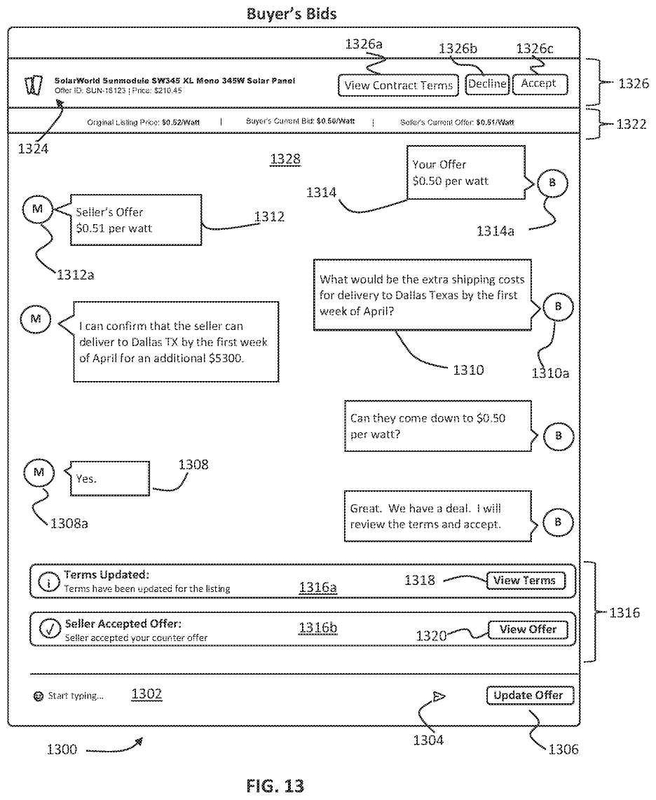

FIGS. 12 and 13 illustrate examples of a chat feature according to an embodiment of the invention. According to the embodiment illustrated in FIGS. 12 and 13, the chat screens are central to negotiating a transaction and generating legally binding agreements. FIG. 12 is a seller-side chat screen 1200 titled Seller's Offers and Inquiries. Chat screen 1200 contains communications between the seller and the moderator, organized chronologically from the top down with the newest messages at the bottom. Embodiments may include a time stamp associated with each message, although none is shown in the drawings. The chat screen includes real time text chat messages 1208, 1210 with avatar labels 1208a, 1210a indicating whether a message is from the moderator (1208a) or the seller (1210a). The example also includes automatically generated system messages 1212, 1214. While these messages are generated by the platform, they include avatar labels 1212a, 1214a attributing them to the moderator and seller respectively, as a matter of convenience, to identify the data direction of flow. In other words, a system message indicating that the seller's offer is “$0.51 per watt” is generated by the system, but it is generated from data entered into the seller account. Thus, it is attributed to the seller with label 1214a. Similarly, a system message indicating that the buyer's offer is “$0.50 per watt” is generated from data entered into the buyer account, but conveyed to the seller through the moderator account. Thus, the system message is attributed to the moderator with label 1212a. Embodiments may include system messages configured to respond to mouse click inputs by launching or instantiating a graphical user interface screen comprising an accept/reject feature. Such a feature may include GUI controls configured to transmit signals to the platform indicating assent to an offer (or bid) or indicating declination of an offer (or bid). Notices 1216 also appear chronologically in the chat screen 1200. For example, an informational notice 1216a indicates that the terms have been updated. A GUI button 1218 is provided for viewing a summary of the terms, without having to study the full contract draft, which is accessible through button 1226a. As used here, the word draft means that the contract is not yet binding for lack of signatures or other manifestation of assent by the parties. The draft contract may be otherwise complete, or may be subject to further negotiation.

Listing data 1224 is provided in the screen header identifying the subject matter under negotiation. The header also includes a set of button controls 1226. One button 1226a provides a copy of the current terms of the contract under negotiation, and a second 1226b and third 1226c button are configured to accept or reject a current offer from the buyer. In some embodiments the contract accessed through button 1226a may be printed for wet signature, it may be signed electronically, or assent may be manifested by means other than signature e.g., through an accept button. The accept 1226b and reject 1226c buttons may be enabled or disabled depending on whether the buyer or the seller has transmitted the most recent counteroffer. Critical deal points are displayed in an information bar 1222 below the decline/accept buttons 1226b/1226c. According to the illustrated embodiment, the data are the original listing price, and the buyer's and seller's current bids.

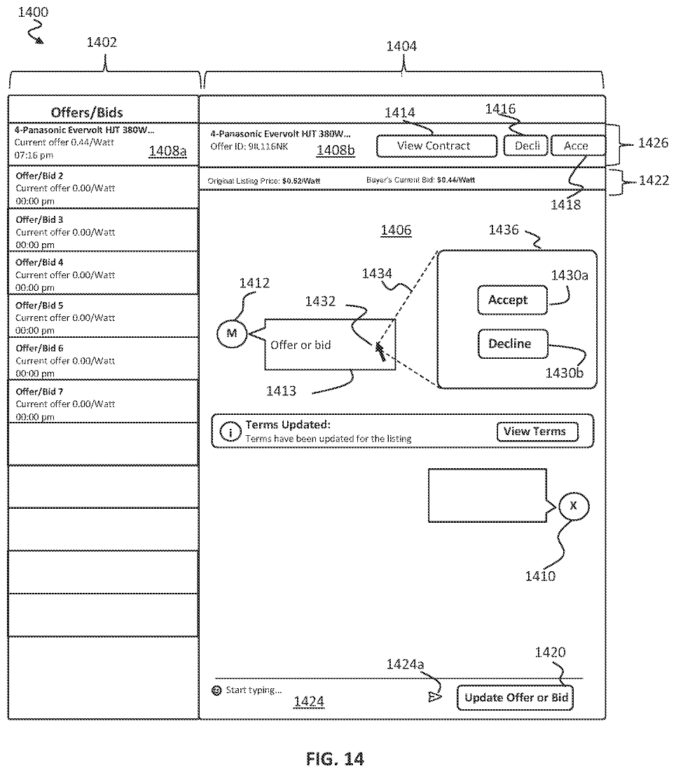

The chat screen 1200 is equipped with a chat box 1202 where new chat messages to the moderator are composed by the seller. The message is sent with a GUI send button 1204, and posted to the chat record 1228. The seller is also provided with a GUI button 1206 for launching a new screen to update the seller's offer. As shown in FIG. 14 with reference to FIG. 12 (FIG. 14 being a generalized chat screen), the seller chat screen 1200 (as well as that of the buyer 1300) may include a side panel 1402 displaying a list of offers 1408a. Clicking a given offer 1408a in the side panel 1402, causes the central panel 1404 to populate with the messages pertaining that offer 1408b. Thus, the seller is enabled to switch quickly between negotiations as new messages arrive.

Turning to FIG. 13, a buyer chat feature 1300 is illustrated. The GUI components of the buyer chat are similar to those of the seller chat feature 1200. FIG. 13 is a buyer-side chat screen 1300 titled Buyer's Bids. Chat screen 1300 contains communications between the buyer and the moderator, organized chronologically from the top down with the newest messages at the bottom. Embodiments may include a time stamp associated with each message, although none is shown in the drawings. The chat screen includes real time text chat messages (1308, 1310), with avatar labels 1308a, 1310a indicating whether a message is from the moderator (1308a) or the buyer (1310a). The example also includes automatically generated system messages (1312, 1314). While these messages are generated by the platform, they include avatar labels 1312a, 1314a attributing them to the moderator and buyer respectively as a matter of convenience, to identify the data direction of flow. In other words, a system message indicating that the buyer's offer is “$0.50 per watt” is generated by the system, but it is generated from data entered into the buyer account. Thus, it is attributed to the buyer with label 1314a. Similarly, a system message indicating that the seller's offer is “$0.51 per watt” is generated from data entered into the seller account, but conveyed to the buyer through the moderator account. Thus, the system message is attributed to the moderator with label 1312a. Notices 1316 also appear chronologically in the chat screen 1300. For example, an informational notice 1316a indicates that the terms have been updated. A GUI button 1318 is provided for viewing a summary of the terms, without having to study the full contract, which is accessible through GUI button 1326a.

Listing data 1324 is provided in the screen header identifying the subject matter under negotiation. The header also includes a set of button controls 1326. One button 1326a provides a copy of the contract under negotiation, and second 1326b and third 1326c buttons are configured to accept or reject a current offer from the buyer. In some embodiments the contract accessed through button 1326a may be printed for wet signature, it may be signed electronically, or assent may be manifested by means other than signature e.g., through an accept button. The accept 1326b and reject 1326c buttons may be enabled or disabled depending on whether the buyer or the seller has transmitted the most recent counteroffer. Critical deal points are displayed in an information bar 1322 below the decline/accept buttons 1326b/1326c. According to the illustrated embodiment the data are the original listing price, and the buyer's and seller's current bids.

The chat screen 1300 is equipped with a chat box 1302 where new text messages to the moderator are composed by the buyer. The message is sent with a send button 1304, and posted to the chat record 1328. The buyer is also provided with a button 1306 for launching a new screen to update the buyer's offer. As shown in FIG. 14 with reference to FIG. 13 (FIG. 14 being a generalized chat screen) the buyer chat screen 1300 (as well as that of the seller 1200) may include a side panel 1402 displaying a list of bids 1408a. Clicking a given bid 1408a in the side panel 1402, causes the central panel 1404 to populate with the messages pertaining that bid 1408b. Thus, the buyer is enabled to switch quickly between negotiations as new messages arrive.

FIG. 14 is a generalized example of a chat screen 1400 according to the embodiments shown in FIGS. 12 and 13, applying equally to both. Furthermore, a similar chat screen 1400 may be made available to a third-party service provider that the moderator chooses to contract with to provide services necessary to closing a given transaction. Each third-party service provider may be provided with a similar chat screen for contracting with the moderator. The chat record panel 1406 contains various system messages, real time chat messages, and informational messages, similar to those described in connection with FIGS. 12 and 13. Avatar labels 1412 and 1410 are provided to differentiate between messages attributed to the moderator 1412 designated as “M”, and those of the other party designated generically in this figure as “X”. FIG. 14 includes an example of features and adaptations enabling a user to accept or decline and offer or bid directly from a chat message 1413. A mouse pointer or cursor 1432 is clicked on a message 1413. The system message 1413 is responsive to mouse clicks, resulting in instantiation 1434 of an accept/decline feature 1436, comprising a GUI accept button 1430a, and decline button 1430b. The buttons 1430a, 1430b are configured to transmit a signal to the platform indicating the user's acceptance or declination of an offer or bid. According to some embodiments, some or all system messages may be broadcast to all parties e.g., buyer, seller, and moderator. For example, a new bid or a new offer may be sent to, and appear in, a seller-side chat screen 1200, a buyer-side chat screen 1300, a moderator-side chat screen 1500, or any other chat screen 1400 as a given transaction may require.

FIGS. 12 through 14 operate according to similar principles. A deal is selected for discussion from list 1408a, launching a chat window with specialized contract negotiation and generation features e.g., 1426, 1422, and 1420. The deal is discussed in a chat window 1404, where certain terms may be agreed upon. A chronological record of the negotiation is viewed in box 1406 including all offers, and updates to the terms of the contract being negotiated. Thus, modifications to the terms are driven by the chat communication. A counterparty may accept or decline an offer. Offers may be simply declined, or a new counteroffer may be proposed. As discussed in relation to FIGS. 12 and 13, the chronologically organized chat screen includes system messages (e.g. 1312), informational messages (e.g. 1316), and summary data 1422 enabling the parties to maintain a clear, concise snapshot of the negotiation history and the current status. When both parties agree to a common set of terms, a pair of contracts is formed between buyer and moderator, and seller and moderator. A copy of the contract is accessible to the buyer, seller, and/or moderator through GUI features such as button 1414.

According to some embodiments, the negotiated terms may be copied by the platform into a template, representing common boilerplate terms that may be static and non-negotiable. In more complex embodiments, one or more portions of the boilerplate may available in a plurality of selectable alternative forms allowing the parties to select the terms most suitable to a given transaction from a limited field of prepared options. In still more complex embodiments, one or more portions of the boilerplate may be editable and fully customizable. Embodiments may also comprise any combination of static, selectable, and fully customizable options.

In addition to system messages, a platform according to embodiments provided herein may notify users of certain events by email or SMS text messaging, or similar external messaging modalities. This may be advantageous to help users remain apprised of the progress of pending transactions without having to keep their attention continuously focused on the platform. For instance, a user may be notified when terms are updated, when a new offer or new bid is received, or when an inquiry is received.

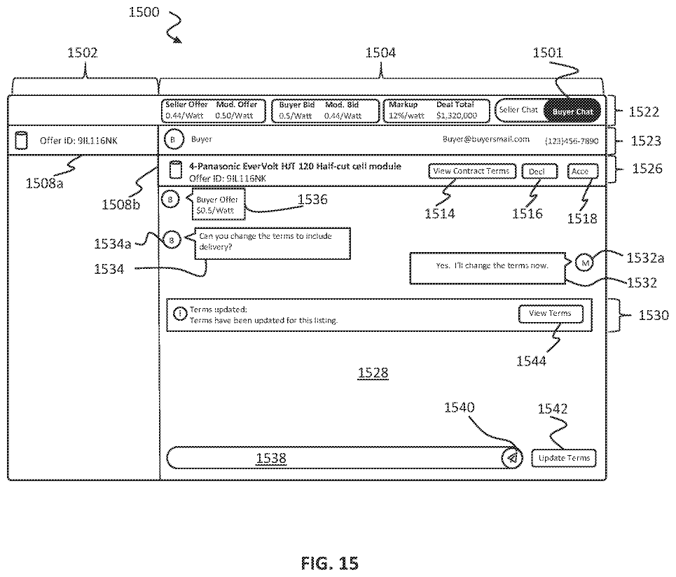

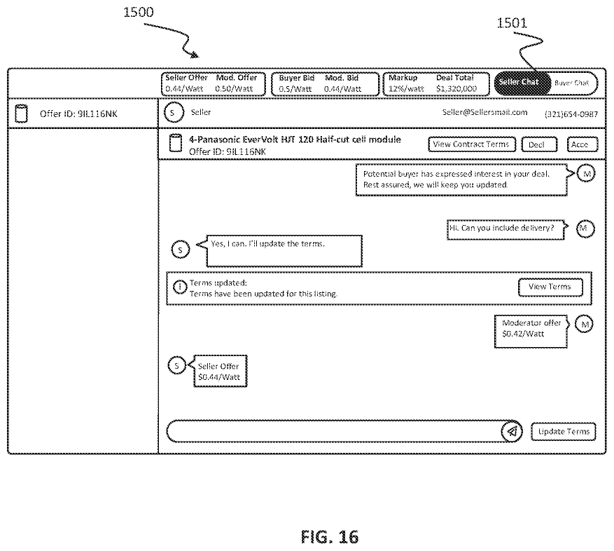

FIGS. 15 and 16 are drawings of a moderator-side chat screen 1500 having a toggle switch 1501 configured to switch between chats with a buyer or seller relative to a given deal 1508a. The screen 1500 includes a side panel 1502 containing a list of deals (only one member 1508a is shown in FIGS. 15 and 16). Clicking on a member 1508a of the list causes the central panel 1504 to populate with data relative to the selected member 1508a, 1508b. The screen 1500 also includes critical information concerning the negotiation in an information bar 1522 e.g., the most recent offer or bid from each party, including the moderator, and the total deal value. Where the toggle 1501 is set to Buyer Chat, the buyer's name and contact details are displayed in a party contact bar 1523. Similar to the buyer and seller screens shown in FIGS. 12 and 13, the moderator is provided with a set of GUI controls for viewing the contract terms 1514, declining an offer 1516, and accepting an offer 1518. The chat record 1528, again similar to the buyer and seller chat screens, includes a chronological record of the chat including system messages 1536, real time text chat messages 1534 and 1532, and informational messages 1530. New chat messages are composed by the moderator in chat box 1538 and sent using GUI send button 1540. Messages are attributed to a party using avatars 1534a and 1532a. The moderator is further provided with a GUI button 1542 for updating the terms under negotiation, as well as another GUI button 1544 for viewing updated terms.

FIG. 16 is the same screen 1500 as shown in FIG. 15, but the toggle switch 1501 is in the Seller Chat position rather than the Buyer Chat position. Accordingly, the messages shown in the chat record are all between the seller and the moderator. Having the ability to switch rapidly between conversations with the buyer and seller allows the moderator to efficiently and reliably manage negotiations with multiple parties in many pending transactions simultaneously. Alternatively, in the absence of a toggle 1501, the moderator would spend much more time navigating between chats, which would diminish productivity.

Platforms according to embodiments described herein may accumulate large amounts of statistical data. Embodiments may further include analytics drawing upon the accumulated historical transactional data record to provide information concerning transactions or potential transactions to users. For example, a given model number may be traded platform-wide by a large number of buyers and sellers, and the price may vary from transaction to transaction. An embodiment may provide real time pricing for a given model number showing e.g. the sale price of the most recent transaction, a moving average price, transaction volume, and so on. The analytics may be displayed in any of a variety of known GUI features adapted to visualize data.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

1. An electronically networked mediated anonymous negotiation system (100A), comprising:
a seller-side communication console (108S) having:
a seller-side transaction panel (301S) having at least one seller-side transaction parameter input field (309S) including a seller-side listing IDentifier field (305S), seller-side price field (303S), and seller-side contract terms field (307S), the seller-side transaction panel (301S) being configured to output a product offer comprising transaction parameters inputted through at least a portion of the at least one transaction parameter field (309S), the seller-side transaction panel (301S) being in data communication with a moderator-side transaction management panel (301M);
a seller-side submit feature (311S) comprising a graphical user interface control, the submit feature (311S) configured to be actuated resulting in transmission of the product offer to the moderator-side transaction management panel (301M);
a seller-side acceptance feature (313S) comprising a graphical user interface control, the seller-side acceptance feature (313S) configured to be actuated resulting in transmission of a manifestation of assent to the product offer to the moderator-side transaction management panel (301M), the assented product offer comprising transaction parameters different from the next previous set of transaction parameters submitted through the seller-side submit feature (311S); and
a seller-side chat panel (315S) in data communication with a moderator-side seller chat subpanel (315MS);
a buyer-side communication console (108B) having:
a buyer-side transaction panel (301B) having at least one buyer-side transaction parameter field (309B) including a buyer-side listing IDentifier field (303B), a buyer-side price field (305B), and buyer-side contract terms (307B), the transaction panel (301B) being configured to output a product offer comprising transaction parameters inputted through at least a portion of the at least one buyer-side transaction parameter field (309B), the transaction panel being in data communication with a moderator-side transaction management panel (301M);
a buyer-side submit (311B) feature comprising a graphical user interface control, the buyer-side submit (311B) feature configured to be actuated resulting in transmission of the product offer to the moderator-side transaction management panel (301M);
a buyer-side acceptance feature (313B) comprising a graphical user interface control, the acceptance feature (313B) configured to be actuated resulting in transmission of a manifestation of assent to the product offer to the moderator-side transaction management panel (301M), the assented product offer comprising transaction parameters different from the next previous set of transaction parameters submitted through the buyer-side submit feature (311B); and
a buyer-side chat panel (315B) in data communication with the moderator-side buyer chat panel (315MB);
a moderator-side mediation console (108M) having:
the moderator-side transaction management panel (301M) having:
a seller subpanel (301MS) in data communication with the seller-side transaction panel (301S) and configured to display transaction parameters (600S) transmitted from the seller-side transaction panel (301S), the seller subpanel (301MS) having moderator-side seller transaction parameter input fields (309MS);
a submit-to-buyer feature (311MS) comprising a graphical user interface control, the submit-to-buyer feature configured to be actuated resulting in transmission of the product offer to the buyer-side transaction panel (301B);
a buyer subpanel (301MB) in data communication with the buyer-side transaction panel (301B) and configured to display transaction parameters (500B) transmitted from the buyer-side transaction panel (301B), the buyer subpanel (301MB) having moderator-side buyer transaction parameter input fields (309MB); and
a submit-to-seller feature (311MB) comprising a graphical user interface control, the submit-to-seller feature (311MB) configured to be actuated resulting in transmission of the product offer to the seller-side transaction panel (108S); and
a moderator-side chat panel (315M) comprising:
a moderator-side seller chat subpanel (315MS) in data communication with the seller-side chat panel (315S); and
a moderator-side buyer chat subpanel (315MB) in data communication with the buyer-side chat panel (315B).

2. The electronically networked mediated anonymous negotiation system of claim 1, further comprising a seller-side product listing panel (800A) having a plurality of transaction parameter input fields (809) including a listing Identifier (806), price (816), and shipping details (817), the product listing panel (800A) being configured to output a product listing comprising transaction parameters inputted through the transaction parameter input fields (809), the product listing panel (800A) being in data communication with a moderator-side product listing management panel (800B).

3. The electronically networked mediated anonymous negotiation system of claim 1, further comprising a moderator-side product listing management panel (800B) configured to assign a status (834) to a listing submitted through the seller-side product listing panel (800A).

4. The electronically networked mediated anonymous negotiation system of claim 1, wherein the product offer outputted by the seller-side transaction panel (301S) comprises a seller-side product offer representing an offer made to, and configured for acceptance through, the moderator-side transaction management panel (301M), and wherein the product offer outputted by the buyer-side transaction panel (301B) comprises a buyer-side product offer representing an offer made to, and configured for acceptance through, the moderator-side transaction management panel (301M).

5. The electronically networked mediated anonymous negotiation system of claim 1, wherein the product offer outputted by the seller-side transaction panel (301S) comprises a seller-side product offer representing an offer made to, and configured for acceptance through, the buyer-side transaction panel (301B), and wherein the product offer outputted by the buyer-side transaction panel (301B) comprises a buyer-side product offer representing an offer made to, and configured for acceptance through, the seller-side transaction panel (301S).

6. The electronically networked mediated anonymous negotiation system of claim 1, wherein the product offer submitted by the moderator to the buyer comprises transaction parameters specified in the seller subpanel (301MS), and wherein the product offer submitted by the moderator to the seller comprises transaction parameters specified in the buyer subpanel (301MB).

7. The electronically networked mediated anonymous negotiation system of claim 1, wherein the buyer-side transaction panel (301B) further comprises a quantity field (1010) configured to receive a quantity of product subject to a bid, the quantity being a non-zero number less than or equal to a quantity on hand (811)

8. The electronically networked mediated anonymous negotiation system of claim 7, wherein the seller-side transaction panel (301S) includes features to receive, negotiate, accept and/or decline an offer for less than all of a quantity on hand (811).

9. The electronically networked mediated anonymous negotiation system of claim 1, wherein a seller-side listing panel 800A includes graphical user interface controls configured to cause the platform to add a listing (801A), edit a listing (801B), delete a listing (801C), and/or duplicate a listing (801C).

10. The electronically networked mediated anonymous negotiation system of claim 1, wherein the seller-side chat panel (315S) includes a graphical user interface control (1226a) configured to cause the platform to generate a contract, and wherein the buyer-side chat panel (315B) includes a graphical user interface control (1326a) configured to cause the platform to generate a contract.

11. The electronically networked mediated anonymous negotiation system of claim 1, further comprising an account creation screen (803) including a graphical user interface feature configured to display terms and conditions, and a graphical user interface control configured to accept the displayed terms and conditions.

12. The electronically networked mediated anonymous negotiation system of claim 1, wherein the moderator-side transaction management panel (301M) includes a markup field (709) configured to add a markup to an offer from moderator to buyer.

13. The electronically networked mediated anonymous negotiation system of claim 1, wherein the moderator-side transaction management panel (301M) includes a commission field (609) configured to subtract a commission from proceeds of a sale.

14. The electronically networked mediated anonymous negotiation system of claim 1, wherein the system further comprises one or more graphical user interface features adapted to receive banking details data (832), wherein the system is adapted to validate the banking details data as a condition precedent to enabling one or more features of the system.

15. The electronically networked mediated anonymous negotiation system of claim 1, wherein a seller-side chat screen (1200) and a buyer-side chat screen (1300) are configured to display system messages transmitted from the moderator, the system messages being responsive to mouse click inputs, wherein system messages (1432) are configured to instantiate an accept/reject feature (1436) in response to the mouse click inputs.

16. The electronically networked mediated anonymous negotiation system of claim 1, wherein the seller-side transaction panel (301S) and/or the buyer-side transaction panel (301B) includes graphical user interface display features configured to display analytic data derived from historical transaction records.

17. An electronically networked mediated anonymous negotiation system, comprising:
a seller-side communication console (108S) having:
a seller-side transaction panel (301S) adapted to bidirectionally communicate product offer data with a moderator-side transaction management panel (301M); and
a seller-side acceptance feature (313S) configured to transmit to the moderator-side transaction management panel (301M) a manifestation of assent to the product offer;
a buyer-side communication console (108B) having:
a buyer-side transaction panel (301B) adapted to bidirectionally communicate product offer data with a moderator-side transaction management panel (301M); and
a buyer-side acceptance feature (313B) configured to transmit to the moderator-side transaction management panel a manifestation of assent to the product offer; and
a moderator-side mediation console (108M) having:
a moderator-side transaction management panel (301M) adapted to bidirectionally communicate product offer data with the seller-side transaction panel (301S), and adapted to bidirectionally communicate product offer data with the buyer-side transaction panel (301B); and
a multilateral chat (315M) feature in bidirectional data communication with a seller-side chat panel (315S), and in bidirectional communication with a buyer-side chat panel (315B).

18. The electronically networked mediated anonymous negotiation system of claim 17, further comprising a seller-side product listing panel (800A) configured to receive data inputs comprising a new product listing and configured to transmit the new product listing to a moderator-side product listing management panel (800B).

19. The electronically networked mediated anonymous negotiation system of claim 17 further comprising a product listing status management feature (834) configured to assign a status to a listing submitted through the seller-side communication console (108S).

20. The electronically networked mediated anonymous negotiation system of claim 17, wherein the product offer data outputted by the seller-side transaction panel (301S) comprises a seller-side product offer representing an offer made to, and configured for acceptance through, the moderator-side transaction management panel (301M), and wherein the product offer outputted by the buyer-side transaction panel (301B) comprises a buyer-side product offer representing an offer made to, and configured for acceptance through, the moderator-side transaction management panel (301M).

21. The electronically networked mediated anonymous negotiation system of claim 17, wherein the product offer outputted by the seller-side transaction panel (301S) comprises a seller-side product offer representing an offer made to, and configured for acceptance through, the buyer-side transaction panel (301B), and wherein the product offer outputted by the buyer-side transaction panel (301B) is a buyer-side product offer representing an offer made to, and configured for acceptance through, the seller-side transaction panel (301S).

22. An electronically networked mediated anonymous negotiation system, comprising:
a seller-side communication console (108S) having:
a seller-side transaction panel (301S) adapted to bidirectionally communicate product offer data with a moderator-side transaction management panel (301M), wherein the product offer data outputted by the seller-side transaction panel (301S) comprises a seller-side product offer representing an offer made to, and configured for acceptance through, the moderator-side transaction management panel (301M), and wherein the product offer outputted by the buyer-side transaction panel (301B) comprises a buyer-side product offer representing an offer made to, and configured for acceptance through, the moderator-side transaction management panel (301M);
a seller-side acceptance feature (313S) configured to transmit to the moderator-side transaction management (301M) panel a manifestation of assent to the product offer; and
a seller-side product listing panel (800A) configured to receive data inputs comprising a new product listing and configured to transmit the new product listing to a moderator-side product listing management panel (800B);
a buyer-side communication console (108B) having:
a buyer-side transaction panel (301B) adapted to bidirectionally communicate product offer data with a moderator-side transaction management panel (301M); and
a buyer-side acceptance feature (313B) configured to transmit to the moderator-side transaction management panel (301M) a manifestation of assent to the product offer; and
a moderator-side mediation console (108M) having:
a moderator-side transaction management panel (301M) adapted to bidirectionally communicate product offer data with the seller-side transaction panel (301S), and adapted to bidirectionally communicate product offer data with the buyer-side transaction panel (301B);
a multilateral chat feature (315M) in bidirectional data communication with a seller-side chat panel (315S), and in bidirectional communication with a buyer-side chat panel (315B); and
a product listing status management feature (834) configured to assign a status to a listing submitted from the seller-side communication console (108S).

23. A method of mediated anonymous negotiation in an electronically networked system, comprising:
a seller generating a product listing including specification of price, shipping details, product identification, and product quantity;
a buyer responding to a product listing, by electronically transmitting to a moderator, alternative terms differing at least in part from the terms of the product listing;
a platform generating a system message to the seller comprising an offer or bid, the system message being displayed in a seller-side chat screen;
the seller clicking the system message resulting in instantiation of an accept/decline graphical user interface feature;
the seller clicking an accept button of the accept/decline graphical user interface feature, wherein clicking the accept button manifests the seller's assent to the bid; and
generating a contract incorporating the terms of the product listing as modified by a the bid.

24. The method of mediated anonymous negotiation in an electronically networked system of claim 23, wherein the product listing constitutes an offer for sale.

25. The method of mediated anonymous negotiation in an electronically networked system of claim 23, wherein the product listing is displayed in an Internet enabled graphical user interface.

26. The method of mediated anonymous negotiation in an electronically networked system of claim 23, further comprising the step of the moderator transmitting a text chat message to the seller, the text chat message being displayed in the seller-side chat screen, and the text chat message comprising the buyer's bid adjusted for incorporating a markup.

27. The method of mediated anonymous negotiation in an electronically networked system of claim 23, wherein the product listing generated by the seller is an unpublished listing pending approval by the moderator.

28. The method of mediated anonymous negotiation in an electronically networked system of claim 27, wherein the unpublished listing is edited by the moderator, the edit including a markup or commission.

29. The method of mediated anonymous negotiation in an electronically networked system of claim 23, wherein the moderator is a human, an artificial intelligence, a rule-based automation module, and/or a large language model.

30. The method of mediated anonymous negotiation in an electronically networked system of claim 23, further comprising the step of transmitting notifications pertaining to the product listing to a buyer or a seller by one or more of email, SMS text, or chat.

31. The method of mediated anonymous negotiation in an electronically networked system of claim 23, wherein the platform generates the system messages and broadcasts some or all of the system messages to the buyer, the seller, and the moderator.

32. The method of mediated anonymous negotiation in an electronically networked system of claim 23, wherein the moderator-side product listing management panel (800B) provides the moderator with features enabling the moderator to approve, reject, edit, or delete a listing.
